(19) United States
(12) Patent Application Publication
(10) Pub. No.: US 2020/0314109 A1
(43) Pub. Date: Oct. 1, 2020

(54) TIME-BASED SERVER ACCESS

(71) Applicant: HEWLETT PACKARD ENTERPRISE DEVELOPMENT LP, Houston, TX (US)

(72) Inventor: Kavitha Subhash, Bangalore (IN)

(21) Appl. No.: 16/371,513

(22) Filed: Apr. 1, 2019

(51) Int. Cl. H04L 29/06

(52) U.S. Cl. CPC H04L 63/108; H04L 63/101

(57) ABSTRACT

A method for accessing a computing device may include receiving a request for access to an object by a user and checking an access control list for permission by the user to access the object, the access control list having an access control entry comprising a time specifier. The method may also include determining a time of the request when the access control entry for the object has the time specifier comparing the time of the request to the time specifier in the access control entry, and allowing the user access to the object when the time request meets a requirement of the time specifier in the access control entry for the object.

### BACKGROUND

Computing devices, such as enterprise servers, provide access to information by various users. Users may access their own information or may access information that is commonly available to a number of users or groups of users. Controlling access to information provides a layer of security, thereby preventing users from accessing, information unless they are authorized to access the information.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a schematic representation of an example computing device for access management, according to one or more examples of the disclosure.

FIG. 2 is a schematic representation of an infrastructure for managing access to objects, according to one or more examples of the disclosure.

FIG. 3 is a flowchart depicting a method for accessing a computing device, according to one or more examples of the disclosure.

FIG. 4 is an example computing, device with a hardware processor and accessible machine-readable instructions, according to one or more examples of the disclosure.

FIG. 5 is a flowchart depicting a method for accessing a computing device, according to one or more examples of the disclosure.

FIG. 6 is an example computing device with a hardware processor and accessible machine-readable instructions, according to one or more examples of the disclosure.

FIG. 7 is a schematic representation of a computer processing device that may be used to implement functions and processes, according to one or more examples of the present disclosure, according to one or more examples of the disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

Computing devices in enterprise solutions may be used to provide access to objects, such as files, processes, terminals, and disks, to multiple users that may be located locally or remotely. Access to certain objects by certain users may occur through the use of various security measures including, for example, password protection and access control lists, which may allow access to objects based on a user's permissions. Access control lists may remain active and thus be applied to each access of an object until a specific access entry is entered in the protection record that denies a user access to the object. Said another way, a user may continue to access an object until an access control list for the object is updated to either deny the user access, a specific entry in the ACL is deleted, thereby denying the user access, or access to the object is frozen.

To prevent access to an object by a user, manual intervention may occur, by which an administrator manually updates the access control list for a particular object. While this may be effective in preventing a user access to a specific object, the process of manual intervention is time consuming and inefficient. Additionally, in certain situations, an administrator may only want to deny access to a user or group of users for a period of time. In order to deny access, then reallow access, intervention may occur numerous times. In certain circumstances, users may be prevented from accessing certain objects on a regular basis. As such, updating access control lists may occur repeatedly and/or at known increments.

Systems and methods disclosed herein may provide security restrictions that allow access specifiers to be added to access control lists that define when a user has access to a particular object. For example, an access specifier may allow user access to an object based on time of day when an access request is received. In such an implementation, access to an object by users may be allowed only during a specific time range, e.g., between two predefined hours within a day. The access specifier may be specific to a user or group off users and may be used to allow or deny access to a specific object by the specific user or group of users. As such, different users may have different access to the same object based on permission specified in the access specifier. In another implementation, an access specifier may allow a user to access an object for a specific duration, e.g., access may be allowed for 2 hours after the first request for access. In still other implementations, an access specifier may allow a user to access a file a specific number of times, e.g., the user may access an object 500 times, and be denied access at attempt 501. In certain implementations, the number of times an object may be accessed may be defined by access to a specific user, while in other implementations, access to an object may be defined as the total number of times the object may be accessed by all users.

Such access specifiers may thereby allow permissions to specific objects to be predefined, thereby reducing manual manipulation of access control lists. Additionally, by providing such access specifiers that are time and count based on substantially continuously operating systems, i.e., computing devices that are substantially always on, access to objects may be more effectively and efficiently controlled. Specific examples and implementations are discussed in detail below.

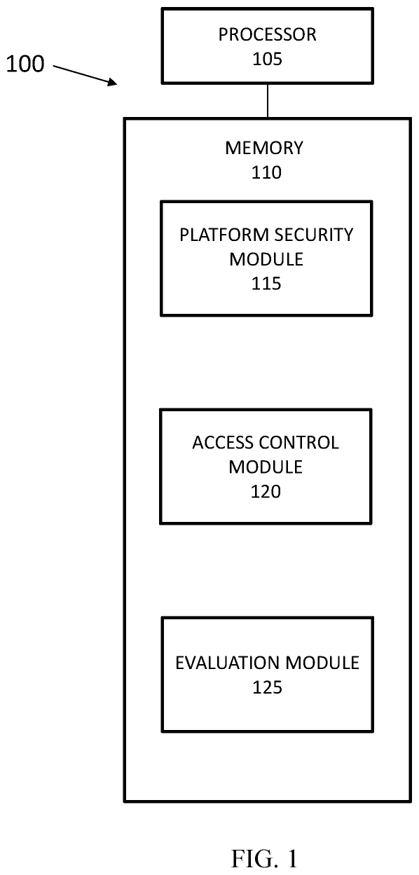

Turning to FIG. 1, a schematic representation of an example computing device 100 for access management according to one or more examples is shown. The computing device 100 may use software, hardware, firmware, or logic to perform functions described herein.

Computing device 100 may include hardware and/or programming instructions configured to share information. The hardware, for example, may include one or more processors 105 (one shown) and memory 110, e.g., computer-readable medium (“CRM”), machine readable medium (“MRM”), database, etc. Processor(s) 105 may include any set of processors capable of executing instructions stored by a memory 110. Processor(s) 105 may be implemented in a single device or distributed across multiple devices. The program instructions, e.g., computer readable instructions (“CRI”) may include instructions stored on the memory 110 and executable by the processor(s) 105 to implement a desired function.

Memory 110 may be in communication with processor 105. Memory 110 may include any set of memory components capable of storing instructions that may be executed by processor 105. Memory 110 may be a non-transitory CRM or MRM. Memory 110 may also be integrated in a single device or distributed across multiple devices. Further, memory 110 may be fully or partially integrated in the same apparatus as processor 105 or it may be separate but accessible to that processor 105. Computing device 100 may be implemented on a participant device, on a server device, on a collection of server devices, or a combination of the participant device and the server device.

A set of modules, e.g., a platform security module 115, an access control module 120, and an evaluation module 125, may include CRI that when executed by the processor 105 can perform functions. The set of modules may be sub-modules of other modules. For example, platform security module 115 and access control module 120 may be sub-modules or contained within the same computing device 100. In another example, the set of modules may include individual modules at separate and distinct locations, e.g., CRM, etc.

As briefly discussed above, computing device 100 may use a number of modules to manage access to objects located on or operatively connected to computing device 100. Each module will be discussed in detail below.

Platform security module 115 may refer to a module that provides user access to computing device 100 and/or objects stored on or otherwise accessible to computing device 100. Platform security module 115 may provide user credentialing, such as password protection that only allows users to access computing device 100 if the user has the proper credentials. Platform security module 115 may include one or more of access control module 120 and/or evaluation module 125 as sub-models. As such, platform security module 115 may provide functionality that is different from or a part of providing access to objects to users.

Access control module 120 may refer to a module that has access control lists (“ACLs”) that are used to control access to specific objects. More specifically, ACLs include a list of permissions attached to an object that specifies which users or system processes are granted access to the specific object, as well as what operations are allowed on given objects. Each entry in an ACL may specify a subject and an operation.

ACLs may be made up of one or more access control entries (“ACEs”). An ACE is an element in an ACL that controls or monitors access to an object by a specified trustee. Each ACE may specify a subject, type of subject, and permissions. Subjects may refer to a user or group of local or remote systems. There may also be provisions to specify the owner of a protection record, who may thereby update the protection record with any changes.

In implementations of the present disclosure, ACEs may include an access specifier. As such, the access specifier may include additional control data that may further restrict access to specific objects. For example, types of access specifiers may include a time specifier and/or a count specifier. A time specifier may include a time specific access parameter and/or a time duration access parameter.

A time specific access parameter may be used to allow access to an object when the request for the object falls within a predefined time range. For example, a time specific access parameter may be included in the time specifier of the ACE for the object that indicates that a particular user only has access to the object between the hours of 9:00:00 and 18:00:00. The time specific access parameter may include time restrictions for seconds, minutes, hours, days, weeks, months, or other specific increments as defined by a system administrator. In one implementation, a time specific access parameter may be used to deny one group of users access to an object, while a different group of users still retains access to the object. In other implementations, a time specific access parameter may be used to deny one or more users in a group of users access to an object while one or more other users in the same group are allowed access to the object. If a request is made for an object having a time specific access parameter, and the request is made outside of the predefined range, the user may be denied access to the parameter.

In one example, a time specifier in an ACE for an object that includes a time specific parameter may include the following entry:

grant-access <object> <user:app.user> Permission: RWE, Start-time 9:00:00<date> End-time 18:00:00 <date>
Such an ACE entry may thereby allow the user read and write permissions for the object between the hours of 9:00:00 and 18:00:00 on the specific date. Outside of the specified time, the user may be denied access to the object.

A time specifier may also include a time duration parameter. A time duration parameter may be used to allow access to an object by a user for a specific duration of time that may start when a request for the object is made. For example, a user may request access to an object at 9:00:00. The object may include an ACE entry that includes a time duration parameter indicating that the user has access to the object for 2:00:00 from the start time of a request. The object may also include an ACE entry that includes a time duration parameter indicating that the user has access to the object for 2:00:00 on a specific date from the start time of the request. Accordingly, an administrator may restrict access to objects for particular lengths of time for particular users.

In one example, a time specifier in an ACE for an object that includes a time duration parameter may include the following entry:

grant-access <object> <user:app.user> Permission: RWE, date: <date> duration: 00:02:00 hours.
Such an ACE entry may thereby allow the user read and write permissions for the object for 2 hours from the start of access on the defined date. After the duration is exceeded, the user may be prevented from accessing or otherwise have read and write permissions for the object.

An access specifier may also include a count parameter. A count parameter allows the number of times a user accesses a specific object to be tracked, and when a predefined number of access attempts are made, denied access to the object. For example, a user may request access to an object that has a count of 500. After a first access request, the count for the object may be reduced by 1 to 499. After 500 access requests are made by the user, the user may be denied access to the object. In certain implementations, counts may refer to access attempts by specific users and/or a number of users within a group. Accordingly, access can be granted, tracked, and/or denied for individual users or a group of users. In still other implementations, counts may refer to the total number of times an object may be accessed. For example, an object with a count of 500 may define the total number of times an object may be accessed by all users as being 500. Thus, each time any user accesses the object, a count may be removed.

Counts may be tracked for a specific object based on access attempts in a number of ways. For example, a count may be added every time an access request is made, or a count may be subtracted from a bank of counts every time an access request is made. The ACE entry for the object may be updated to reflect the current count when an access request is made, or the counts may be stored outside the ACE, thereby allowing modules of computing device 100 to track the counts.

In one example, an access specifier in an ACE for an object that includes a count parameter may include the following entry:

grant-access <object> <user:app.user> Permission: RWE, date: <date> access count: 500
Such an ACE entry may thereby allow the user read and write permissions for the object 500 times on the specific date. In addition to controlling access for a specific number of time on a date, the counts may be indefinite, meaning that no date range is defined. In addition to a day being specified, other ranges may be included, such as, weeks, months, years, etc.

In certain implementations, multiple types of access specifiers may be included for a particular object. For example, an object may include an ACE entry that includes both time specifiers and/or count specifiers. In such implementations, multiple access specifiers may be combined in a single ACE entry, or the access specifiers may be separate ACE entries.

As mentioned above, access control module 120 may store the ACLs including the ACEs that define access parameters, such as access specifiers, for a number of objects. A user may request access to an object, and access control module 120 may determine whether the user has access permissions for the object. If the user does not have access permissions for the object, access control module 120 may indicate to platform security module 115, or other modules or sub-modules, that the user does not have access permissions, and the user may be denied access to the object. If access control module 120 determines that the user has access to the object, information about the object may be provided for analysis by evaluation module 125.

Evaluation module 125 may refer to a module that analyzes an ACL for an object and determines whether a user has access to the object based on an access specifier. For example, evaluation module 125 may be provided an ACL including an ACE that has a time specifier. Evaluation module 125 may compare the time of the request to the time specifier and determine whether the user has access to the object. If the user has access to the object, the evaluation module 125 may provide instructions to platform security module 115, or other modules and/or sub-modules, to allow access to the object. If evaluation module 125 determines that the user does not have permissions for the object, evaluation module 125 may instruct platform security module 115 to deny access to the user.

Evaluation module 125 may also record information about an object based on an access specifier. For example, evaluation module 125 may store information about time access for objects, as well as count access for objects. Evaluation module 125 may also be used to modify the ACE for an object based on the access specifier. For example, evaluation module 125 may update the count in an ACE for an object based on the number of requests a user makes for the object. Evaluation module 125 may further update an ACE when an access time for an object is exceeded or otherwise falls outside of a predetermined range. In other implementations, access control module 120 may update the ACL and/or ACEs for an object either independently or based on instructions from evaluation module 125. For example, if during authorization for an object the time specified for access to the object is expired, then the particular entry may be adjusted or otherwise removed, thereby preventing further access to the object by the user unless the ACL for the object is subsequently updated by an administrator.

By providing access specifiers, such as time specifiers and/or count specifiers, access to objects may be further controlled, thereby further securing objects within or accessible through computing device 100.

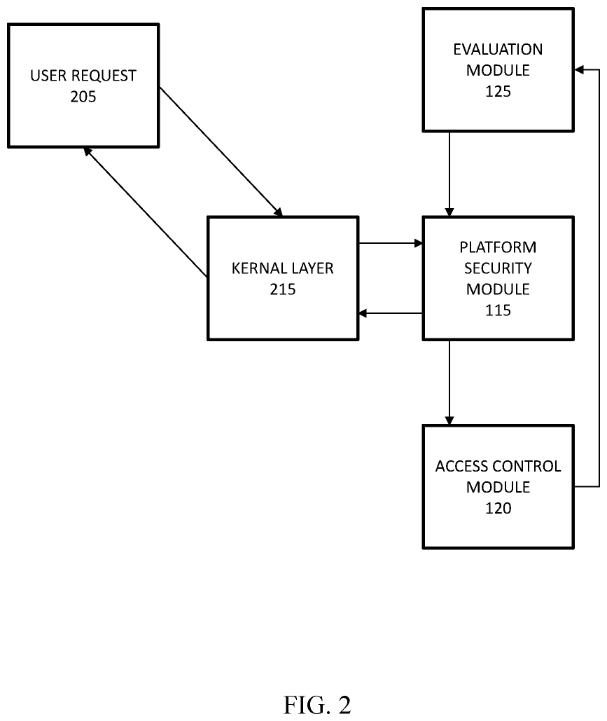

Referring to FIG. 2, a schematic representation of an infrastructure for managing access to objects, according to one or more examples is shown. In this example, a user may initiate a user request 205 for access to an object in a computing system. User request 205 may occur through an application or through command line instructions, and may request access to, for example, files, processes, disks, and the like. The user request may initially be processed through a kernel layer 215 of the operating system, which allows the user to access platform security module 115.

As discussed above, platform security module 115 may include security provisions that request a user to provide access credentials to access the computing device. After verification of the user's access credentials, user request 205 may proceed to access control module 120. Access control module 120 may include ACLs for a plurality of objects, each ACL including one or more ACEs that define whether a user may be provided access to a specific object.

Initially, access control module 120 may access an ACL for the object in user request 205 and determine if the object is protected. If the object is not protected, access control module 120 may provide instructions through kernel layer 215 to provide the user access to the object. If the object is protected, access control module 120 may determine whether the object has an ACE that includes an access specifier. If the ACL does not have an ACE that includes an access specifier, access control module 120 may provide instructions through kernel layer 215 to provide the user access to the object.

If access control module 120 determines that the ACL has an ACE entry for the object that includes an access specifier, access control module 120 may send user request 205 to evaluation module 125. In certain implementations, user request 205 may be sent through platform security module 115, or in other implementations, may be sent directly to evaluation module 125. In still other implementations, evaluation module 125 may a sub-module of access control module 120.

On receipt of user request 205, evaluation module 125 may determine whether the user has permission to access the object based on an evaluation of the access specifier. For example, if the access specifier is a time specifier, evaluation module 125 may compare the time of user request 205 to the time the object is accessible by the user as defined by the ACE. If the time of user request 205 falls within the time specific parameter or the time duration parameter, the user may be provided access to the object. If, however, one or more of the time specific parameter and/or the time duration parameter are not met, the user may be denied access to the object. In still other implementations, user request 205 may request access to an object that has a count specifier in an ACE of the ACL. In such an implementation, evaluation module 125 may determine whether enough counts remain, thereby allowing the user to access the object.

When evaluation modules 125 determines that the user has access to the object, evaluation module 125 may provide instructions to platform security module 115 indicating that access to the object by the user is allowed. In other implementations, evaluation module 125 may directly provide instructions through kernel layer 215 to allow access to the object.

While the progression of user request 205 in FIG. 2 flows through kernel layer 215, platform security module 115, access control modules 120, and evaluation module 125, in other implementations, one or more of the specific modules may be excluded. Additionally, other modules that provide other layers of security may be included as additional modules or sub-modules of one or more of platform security module 115, access control module 120, and/or evaluation module 125.

Several examples of how user requests 205 may occur are provided below. For example, in a certain implementation two user groups may be defined, a Manager Group and a Human Resources Group. Both groups may be authorized to access the same database containing a number of objects. During certain time periods, for example during payroll processing, denial of access to all users not in the Human Resources Group may be desirable. To deny access to all users not in the Human Resources Group, a time specifier may be added to an ACL for one or more objects that indicates on a certain date and/or for a certain time, write access may be allowed for the Human Resources Group. Any user not in the Human Resources Group may then be denied access to certain protected objects during the defined time period.

In other implementations, such as in a banking sector, it may be beneficial to provide a time specifier including a duration access parameter that allows access to funds during the specific duration, thereby preventing unintentional withdrawals and/or unauthorized access. In the retail sector, implementations may include controlling access to specific objects during festivals or large events, thereby increasing the performance of associated systems by denying access to certain users while the event is ongoing. Other sectors may also benefit from implementations of the present disclosure including, for example, the finance sector, governmental organizations, insurance, and the like.

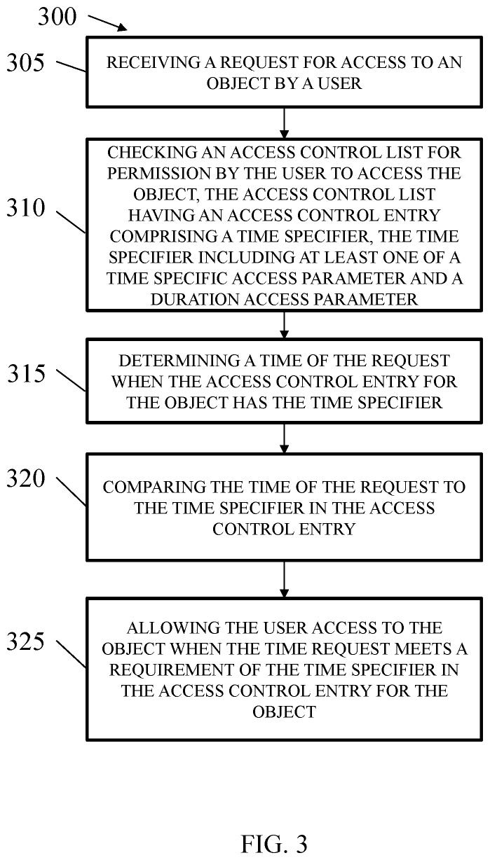

Referring to FIG. 3, a flowchart depicting a method 300 for accessing a computing device, according to one or more examples is shown. In operation, method 300 may include receiving (block 305) a request or access to an object by a user. The request may be made through an application or through a command line interface. The user may be an individual user, or may be part of a group of users, and as such, the request may be a request made by the group for access to the object. The object may include, for example, files, processes, disks, and the like.

In operation, method 300 may include checking (block 310) an ACL for permission by the user to access the object, the ACL having an ACE having a time specifier, the time specifier including at least one of a time specific access parameter and a duration access parameter. The time specific access parameter may be used to provide a user access to an object during a define time range. In certain implementations, the time specific access parameter may include a start time and an end time. As such, the user may be allowed access to the object if the request is made after the start time and before the end time.

The duration access parameter may be used to provide a user access to an object for a limited amount of time, which starts at the time the request is made and/or access to the object is allowed the first time. In such an implementation, a start time for the object may be recorded, such that the start time is the time of the request for access to the object. The user may then be allowed access for a predefined amount of time before access to the object is denied.

In certain implementations, in addition to a time specifier, an ACE for an object may also include a count specifier. The count specifier may allow access to an object by a user a specific number of times before access to the object is denied. Use of a count specifier may include recording a count for the object every time an access request for the object is made by a user. In certain implementations, when the user is part of a group, a count may be recorded for each access by any user within the group, thereby only allowing the group a set number of access requests before access to the object is denied. As used herein, recording a count may include adding a count, subtracting a count, or otherwise noting that an access request for an object is made by a user. The access request, and thus the count, may be stored in the ACE, or within a module of the computing device, as explained above.

In operation, method 300 may include determining (block 315) a time of the request when the ACE for the object has the time specifier. When the ACE for an object includes a time specifier a computing device and/or module thereof may determine the time of the request by, for example, by checking the clock time of the computing device. In certain implementations, the user request may occur remote from the computing device, e.g., from a different location not connected to the computing device, and as such, the time at the remote location may differ from the computing device clock time. In such an implementation, the time of the request for the object may be adjusted to the computing device time, thereby harmonizing the times between the remote location and the computing device.

In operation, method 300 may include comparing (block 320) the time of the request to the time specifier in the ACE. As the ACE may include a predefined time specific access parameter and/or a duration access parameter, the time of the request may be compared to determine whether the time request either falls within a time range or during a time duration within the ACE.

In operation, method 300 may include allowing (block 325) the user access to the object when the time request meets a requirement of the time specifier in the ACE for the object. The requirement of the time specifier may include various types of time-based requirements, such as, for example, the time specific access parameter and/or the duration access parameter, as discussed in detail above. In other implementations, the requirement of the time specifier may refer to any type of time information that may be used to either allow or deny access to a user. In circumstances where the time request does not meet the requirements of the time specifier, the user may be denied access to the object.

If a user is denied access to the object, a recording of the denial and a reason for the denial may occur. The reason for the denial may include indicating that the user attempted to access the object outside of an allowed time period. The reason for the denial may also include indicating that the user attempted to access the object for a time period that was to long or the user attempted to access the object to many times. By recording the reason for the denial, an administrator may review the denials to determine if the reason for the denial was incidental, accidental, or whether the attempt was malicious. By verifying malicious access attempts, the computing device may be further secured from attacks, either internal or external. The denials may also be reviewed to determine if there are incorrect ACEs in ACLs for specific objects.

In certain implementations, it may be determined that a time request is expired, e.g., the user no longer has access to an object. In such an implementation, the ACL for the object may be adjusted, thereby cleaning up the ACL list of extraneous permissions. For example, an ACE entry for the object may be deleted and/or other permissions may be added, deleted, or otherwise modified. By allowing for adjustment of the ACLs when expired time requests are identified, the ACL may be maintained in a more accurate state.

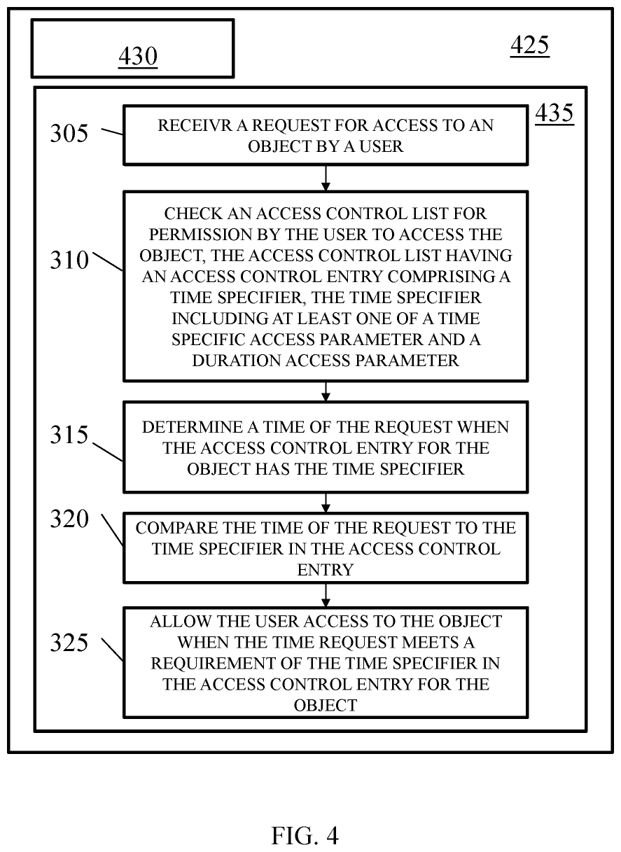

Referring to FIG. 4, an example computing device with a hardware processor and accessible machine-readable instructions, according to one or more examples is shown. FIG. 4 provides an example computing device 425, with a hardware processor 430, and accessible machine-readable instructions stored on a machine-readable medium 435 for generating information about a product as discussed above with respect to one or more disclosed example implementations. FIG. 4 illustrates computing device 425 configured to perform the flow described in blocks 305, 310, 315, 320, and 325, discussed in detail with respect to FIG. 3. However, computing device 425 may also be configured to perform the flow of other methods, techniques, functions, or processes described in this disclosure.

A machine-readable storage medium, such as 435 of FIG. 4, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (“EPROM”), random access memory (“RAM”), non-volatile random access memory (“NVRAM”), optical disk, solid state drive (“SSD”), flash memory chips, and the like. The machine-readable storage medium may be a non-transitory storage medium, where the term “non-transitory” does not encompass transitory propagating signals.

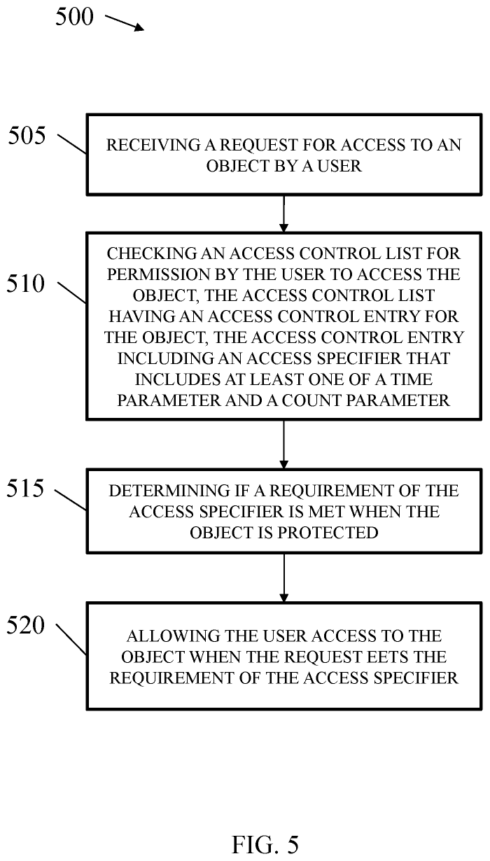

Referring to FIG. 5, a flowchart depicting a method 500 for accessing a computing device, according to one or more examples is shown. In operation, method 500 may include receiving (block 505) a request for access to an object from a user. The request for access to the object may occur substantially as explained above with respect to FIG. 3.

In operation, method 500 may include checking (block 510) an ACL for permission to access the object, the ACL having an ACE for the object, the ACE including an access specifier that includes at least one of a time specifier and a count specifier. The time specifier may include one or more of a time specific access parameter and a duration access parameter. As such, in certain implementations, a time of the request may be recorded, thereby allowing the time of the request to be compared to the time specifier. In other implementations, a number of access attempts for the object may be recorded, thereby allowing the access attempts to be counted and recorded each time an access attempt occurs.

In operation, method 500 may include determining (block 515) if a requirement of the access specifier is met when the object is protected. The ACL may first determine whether or not the object is protected. If the object is not protected, no further analysis may occur, and the object may be accessed by the user. In other implementations, the user may be denied access to the object by the ACL because the object is specifically protected from the user in the ACL. In such a circumstance, the user may be denied access to the object and no other actions taken. When the object is protected, a determination of whether the requirement of the access specifier is satisfied may occur. The requirement of the access specifier may include a time specific access parameter, a duration access parameter, and/or a count specifier. The determination may thus include comparing a time of the request or a number of recorded access attempts for the object against the value specified in the requirement.

In operation, method 500 may include allowing (block 520) the user access to the object when the request meets the requirement of the access specifier. When the requirement of the access specifier is met, the user may be either directly or indirectly provided access to the object. However, when the requirement of the access specifier is not met, the user may be denied access to the object. For example, if a user attempted to access the object too many times, the count requirement of the access specifier may not be met, and the user may be denied access to the object. In other implementations, the user may attempt to access an object outside of a specified time period, or for too long. In either circumstance, access to the object may be denied.

In other implementations, method 500 may include recording a denial and a reason for the denial, as discussed above with respect to FIG. 3. Furthermore, method 500 may include adjusting the ACL when a time request is expired, and/or adjusting the time of the request to match a computing device time, when the request is remote from the computing device.

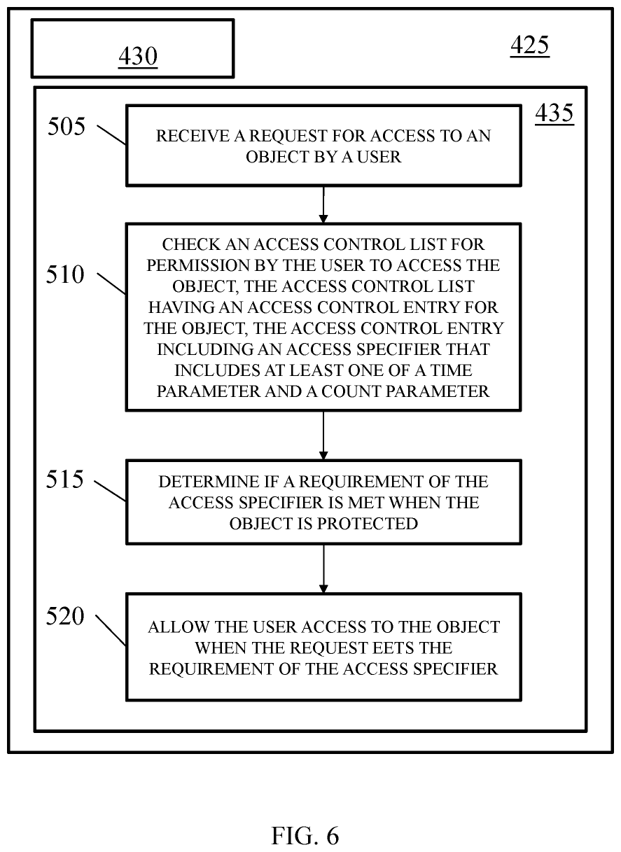

Referring to FIG. 6, an example computing device with a hardware processor and accessible machine-readable instructions, according to one or more examples is shown. FIG. 6 provides similar structural components discussed above with respect to FIG. 4, and as such, for purposes of clarity, only the differences in the figures will be discussed herein. FIG. 6 provides an example computing device 425, with a hardware processor 430, and accessible machine-readable instructions stored on a machine-readable medium 435 for managing data as discussed above with respect to one or more disclosed example implementations. FIG. 6 illustrates computing device 425 configured to perform the flow described in blocks 505, 510, 515, and 520, discussed in detail with respect to FIG. 5.

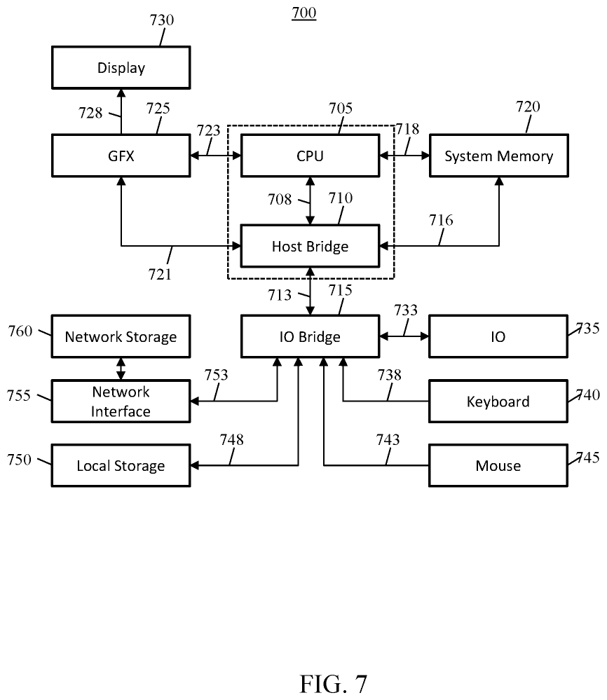

Turning now to FIG. 7, a schematic representation of a computer processing device 700 that may be used to implement functions and processes in accordance with one or more examples of the present disclosure is shown. FIG. 7 illustrates a computer processing device 700 that may be used to implement the systems, methods, and processes of this disclosure. For example, computing device 700 illustrated in FIG. 7 could represent a client device or a physical server device and include either hardware or virtual processor(s) depending on the level of abstraction of the computing device. In some instances (without abstraction), computing device 700 and its elements, as shown in FIG. 7, each relate to physical hardware. Alternatively, in some instances one, more, or all of the elements could be implemented using emulators or virtual machines as levels of abstraction. In any case, no matter how many levels of abstraction away from the physical hardware, computing device 700 at its lowest level may be implemented on physical hardware. In one implementation, computing device 700 may allow a subscriber to remotely access one or more data centers. Similarly, the management tool used by the subscriber may include a software solution that runs on such a computing device 700.

FIG. 7 shows a computing system 700 in accordance with one or more examples of the present disclosure. Computing system 700 may be used to implement aspects of the present disclosure, such as an orchestrator, a gateway manager, a cloud monitor, a local storage, a cloud-based storage, or any other device that may be used implementing the systems and methods for managing data discussed herein. Computing system 700 may include one or more central processing units (singular “CPU” or plural “CPUs”) 705 disposed on one or more printed circuit boards (not otherwise shown). Each of the one or more CPUs 705 may be a single-core processor (not independently illustrated) or a multi-core processor (not independently illustrated). Multi-core processors typically include a plurality of processor cores (not shown) disposed on the same physical die (not shown) or a plurality of processor cores (not shown) disposed on multiple die (not shown) that are collectively disposed within the same mechanical package (not shown). Computing system 700 may include one or more core logic devices such as, for example, host bridge 710 and, input/output (“IO”) bridge 715.

CPU 705 may include an interface 708 to host bridge 710, an interface 718 to system memory 720, and an interface 723 to one or more IO devices, such as, for example, graphics processing unit (“GFX”) 725. GFX 725 may include one or more graphics processor cores (not independently shown) and an, interface 728 to display 730. In certain examples, CPU 705 may integrate the functionality of GFX 725 and interface directly (not shown) with display 730. Host bridge 710 may include an interface 708 to CPU 705, an interface 713 to IO bridge 715, for examples where CPU 705 does not include interface 718 to system memory 720, an interface 716 to system memory 720, and for examples where CPU 705 does not include integrated GFX 725 or interface 723 to GFX 725, an interface 721 to GFX 725. One of ordinary skill in the art will recognize that CPU 705 and host bridge 710 may be integrated, in whole or in part, to reduce chip count, motherboard footprint, thermal design power, and power consumption. IO bridge 715 may include an interface 713 to host bridge 710, one or more interfaces 733 to one or more IO expansion devices 735, an interface 738 to keyboard 740, an interface 743 to mouse 745, an interface 748 to one or more local storage devices 750, and an interface 753 to one or more network interface devices 755.

Each local storage device 750 may be a solid-state memory device, a solid-state memory device array, a hard disk drive, a hard disk drive array, or any other non-transitory computer readable medium. Each network interface device 755 may provide one or more network interfaces including, for example, Ethernet, Fibre Channel, WiMAX, Wi-Fi®, Bluetooth®, or any other network protocol suitable to facilitate networked communications. Computing system 700 may include one or more network-attached storage devices 760 in addition to, or instead of, one or more local storage devices 750. Network-attached storage device 760 may be a solid-state memory device, a solid-state memory device array, a hard disk drive, a hard disk drive array, or any other non-transitory computer readable medium. Network-attached storage device 760 may or may not be collocated with computing system 700 and may be accessible to computing system 700 via one or more network interfaces provided by one or more network interface devices 755.

One of ordinary skill in the art will recognize that computing system 700 may include one or more application specific integrated circuits (“ASICs”) that are configured to perform a certain function, such as, for example, hashing (not shown), in a more efficient manner. The one or more ASICs may interface directly with an interface of CPU 705, host bridge 760, or IO bridge 715. Alternatively, an application-specific computing system (not shown), sometimes referred to as mining systems, may be reduced to only those components necessary to perform the desired function, such as hashing via one or more hashing ASICs, to reduce chip count, motherboard footprint, thermal design power, and power consumption. As such, one of ordinary skill in the art will recognize that the one or more CPUs 705, host bridge 710, IO bridge 715, or ASICs or various sub-sets, super-sets, or combinations of functions or features thereof, may be integrated, in whole or in part, or distributed among various devices in a way that may vary based on an application, design, or form factor in accordance with one or more example examples. As such, the description of computing system 700 is merely an example and not intended to limit the type, kind, or configuration of components that constitute a computing system suitable for performing computing operations, including, but not limited to, hashing functions. Additionally, one of ordinary skill in the art will recognize that computing system 700, an application specific computing system (not shown), or combination thereof, may be disposed in a standalone, desktop, server, or rack mountable form factor.

One of ordinary skill in the art will recognize that computing system 700 may be a cloud-based server, a server, a workstation, a desktop, a laptop, a netbook, a tablet, a smartphone, a mobile device, and/or any other type of computing system in accordance with one or more example examples.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A method for accessing a computing device, the method comprising:
receiving a request for access to an object by a user;
checking an access control list for permission by the user to access the object, the access control list having an access control entry comprising a time specifier, the time specifier including at least one of a time specific access parameter and a duration access parameter;
determining a time of the request when the access control entry for the object has the time specifier;
comparing the time of the request to the time specifier in the access control entry; and
allowing the user access to the object when the time request meets a requirement of the time specifier in the access control entry for the object.

2. The method of claim 1, wherein the time specific access parameter comprises a start time and an end time.

3. The method of claim 1, wherein the duration access parameter comprises a period of time.

4. The method of claim 3, further comprising recording a start time for the object, wherein the start time is the time of the request.

5. The method of claim 1, wherein the access control entry further comprises a count specifier.

6. The method of claim 5, further comprising recording a count for the object.

7. The method of claim 1, further comprising denying the user access to the object when the time request does not meet the requirement of the time specifier.

8. The method of claim 7, further comprising recording a denial and a reason for the denial when the time request does not meet the requirement of the time specifier.

9. The method of claim 1, further comprising adjusting the access control list when the time request is expired.

10. The method of claim 1, further comprising adjusting the time to a computing device time when the request for access to the object is remote.

11. The method of claim 1, further comprising verifying an access credential for the user.

12. A system for controlling access to an object, the system comprising:
a computing device having a processor and a memory;
a platform security module stored in the memory, the platform security module to verify an access credential for a user;
an access control list module stored in the memory and operatively connected to the platform security module, the access control list module having a plurality of access control lists that correspond to a plurality of objects;
an evaluation module stored in the memory and operatively connected to the access control list module and the platform security module, the evaluation module to evaluate a time of a request for one of the plurality of objects based on a time specifier in an access control entry in the access control list for the object, and when the time of the request meets a requirement of the time specifier, allow access to the object.

13. The system of claim 12, wherein the evaluation module is to record a start time for the object, wherein the start time is the time of the request.

14. The system of claim 12, wherein the evaluation module is to record a count for the object.

15. The system of claim 12, wherein the requirement of the time specifier comprises a time specific access parameter, the time specific access parameter comprising a start time and an end time.

16. The system of claim 12, wherein the evaluation module is to adjust the access control list for the object when the time of the request is expired.

17. A non-transitory computer readable medium comprising computer executable instructions stored thereon that, when executed by a processor in a source system, cause the processor to:
receive a request for access to an object from a user;
check an access control list for permission to access the object, the access control list having an access control entry for the object, the access control entry including an access specifier that includes at least one of a time specifier and a count specifier;
determine if a requirement of the access specifier is met when the object is protected; and
allow the user access to the object when the request meets the requirement of the access specifier.

18. The non-transitory machine-readable storage medium of claim 17, further comprising instructions that when executed by the processor cause the processor to record a time of the request for the object.

19. The non-transitory machine-readable storage medium of claim 17, further comprising instructions that when executed by the processor cause the processor to record a count for the object.

20. The non-transitory machine-readable storage medium of claim 17, further comprising instructions that when executed by the processor cause the processor to deny the user access to the object when the request does not meet the requirement of the access specifier.
